(19) United States
(12) Patent Application Publication
(10) Pub. No.: US 2022/0055631 A1
(43) Pub. Date: Feb. 24, 2022

(54) SENSOR MONITORING IN A VEHICLE

(71) Applicant: Micron Technology, Inc., Boise, ID (US)

(72) Inventors: Srinivasa Anuradha Bulusu, Boise, ID (US); Shannon M. Hansen, Boise, ID (US); Debra M. Bell, Boise, ID (US); Barbara J. Bailey, Kuna, ID (US)

(21) Appl. No.: 16/997,688

(22) Filed: Aug. 19, 2020

(51) Int. Cl. B60W 40/08; H04W 4/48; H04W 4/44; B60W 60/00

(52) U.S. Cl. CPC B60W 40/08; H04W 4/48; H04W 4/44; B60W 2540/221; B60W 60/0051; B60W 2040/0872; B60W 60/0016

(57) ABSTRACT

Methods, devices, and systems related to sensor monitoring in a vehicle are described. In an example, a method can include receiving a trained artificial intelligence (AI) model at a memory device in a vehicle, transmitting the trained AI model to a processing resource in the vehicle, receiving, at the processing resource, data associated with a person located in the vehicle from a sensor included in a computing device and data associated with the vehicle from a sensor included in the vehicle, inputting the received data into the AI model at the processing resource, and sending a command in response to an output of the AI model.

### TECHNICAL FIELD

The present disclosure relates generally to sensor monitoring in a vehicle.

### BACKGROUND

A vehicle can include one or more sensors. Operations can be performed based on data collected by the one or more sensors. For example, the vehicle can notify a driver of the vehicle that the vehicle is low on oil or gas.

A computing device can include a mobile device (e.g., a smart phone), a medical device, or a wearable device, for example. Computing devices can also include one or more sensors and perform operations based on data collected by the one or more sensors. For example, some computing devices can detect and store your location.

### BRIEF DESCRIPTION OF THE DRAWINGS

FIG. 1 illustrates an example of a computing device in accordance with a number of embodiments of the present disclosure.

FIG. 2 illustrates an example of a vehicle in accordance with a number of embodiments of the present disclosure.

FIG. 3 illustrates an example of a system including a computing device and a vehicle in accordance with a number of embodiments of the present disclosure.

FIG. 4 is a flow diagram of a method for sensor monitoring in a vehicle in accordance with a number of embodiments of the present disclosure.

### DETAILED DESCRIPTION

The present disclosure includes methods, apparatuses, and systems related to sensor monitoring in a vehicle. An example method includes receiving a trained artificial intelligence (AI) model at a memory device in a vehicle, transmitting the trained AI model to a processing resource in the vehicle, receiving, at the processing resource, data associated with a person located in the vehicle from a sensor included in a computing device and data associated with the vehicle from a sensor included in the vehicle, inputting the received data into the AI model at the processing resource, and sending a command in response to an output of the AI model.

The trained AI model can be trained outside of the vehicle. For example, a cloud computing system can train the AI model with generic data and send the trained AI to the vehicle and/or a computing device. The vehicle and/or the computing device can store the AI model in a memory device. In some examples, the trained AI model can be updated periodically or in response to new generic data being used to train the AI model.

A processing resource can receive the trained AI model directly from a cloud computing system or a memory device. The processing resource can also receive data. The data can be collected from one or more sensors included in a vehicle, a wearable device, a medical device, and/or a mobile device.

AI operations can be performed on the data using the AI model. The processing resource can include components configured to perform AI operations. In some examples, AI operations can include machine learning or neural network operations, which may include training operations or inference operations, or both.

One or more commands can be generated, sent, and executed in response to an output of the AI model. The commands can be sent to and executed by a computing device and/or a vehicle. Commands can include instructions to provide information, perform a function, or initiate autonomous driving of the vehicle, for example.

As used herein, “a number of” something can refer to one or more of such things. For example, a number of computing devices can refer to one or more computing devices. A “plurality” of something intends two or more.

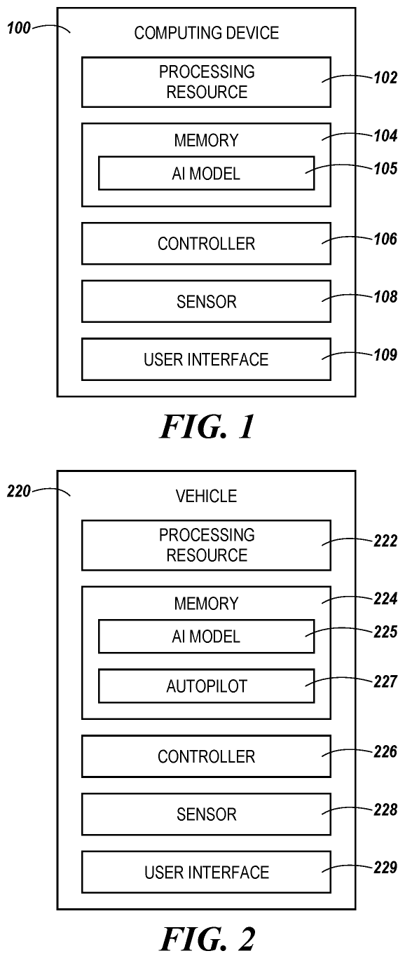

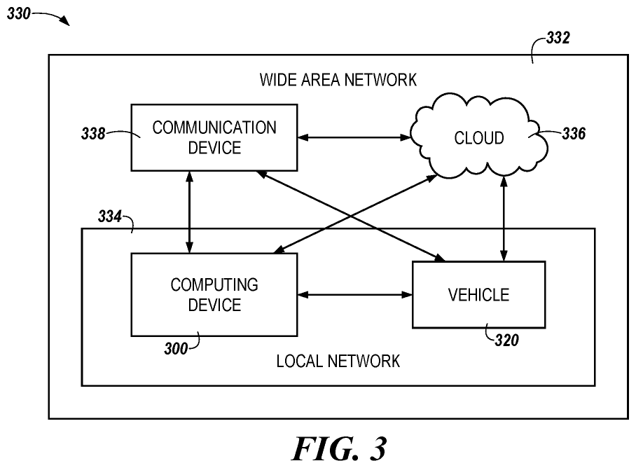

The figures herein follow a numbering convention in which the first digit or digits correspond to the drawing figure number and the remaining digits identify an element or component in the drawing. Similar elements or components between different figures may be identified by the use of similar digits. For example, reference numeral 100 may reference element “0” in FIG. 1, and a similar element may be referenced as 300 in FIG. 3. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

FIG. 1 illustrates an example of a computing device 100 in accordance with a number of embodiments of the present disclosure. The computing device 100 can be, but is not limited to, a wearable device, a medical device, and/or a mobile device. The computing device 100, as illustrated in FIG. 1, can include a processing resource 102, a memory 104 including an AI model 105, a controller 106, one or more sensors 108, and a user interface 109.

The memory 104 can be volatile or nonvolatile memory. The memory 104 can also be removable (e.g., portable) memory, or non-removable (e.g., internal) memory. For example, the memory 104 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 104 is illustrated as being located within computing device 100, embodiments of the present disclosure are not so limited. For example, memory 104 can be located on an external apparatus (e.g., enabling computer readable instructions to be downloaded over the Internet or another wired or wireless connection).

Memory 104 can be any type of storage medium that can be accessed by the processing resource 102 to perform various examples of the present disclosure. For example, the memory 104 can be a non-transitory computer readable medium having computer readable instructions (e.g., computer program instructions) stored thereon that are executable by the processing resource 102 to receive the trained AI model 105, receive data associated with a person located in a vehicle (e.g., vehicle 220 in FIG. 2) from a sensor 108 included in and/or coupled to the computing device 100 and data associated with the vehicle from a sensor (e.g., sensor 228 in FIG. 2) included in and/or coupled to the vehicle, input the received data into the AI model 105, and send a command in response to an output of the AI model 105.

The AI model 105 can be trained outside of the computing device 100. For example, a cloud computing system (e.g., cloud computing system 336 in FIG. 3) can train the AI model 105 with generic data and send the AI model 105 to the computing device 100. The computing device 100 can store the AI model 105 in memory 104 of the computing device 100. In some examples, the AI model 105 can be updated and/or replaced periodically and/or in response to new data being used to train the AI model 105.

The processing resource 102 can receive the AI model 105 directly from a cloud computing system, memory 104, or memory (e.g., memory 224 in FIG. 2) of the vehicle. The processing resource 102 can also receive data. The data can be collected from the one or more sensors 108 included in and/or coupled to the computing device 100 and/or the one or more sensors included in and/or coupled to the vehicle and can be stored in memory 104 and/or memory of the vehicle.

The one or more sensors 108 of the computing device 100 can collect data associated with a person located in the vehicle, for example, the one or more sensors 108 can detect a user's movement, heart rate, temperature, facial expression, body language, identity, eyelids, eye dilation, eye direction, or voice. The one or more sensors 108 can include, but are not limited to, an accelerometer, gyroscope, temperature sensor, proximity sensor, camera, fingerprint scanner, retinal scanner, photodiode, infrared light emitting diode (LED), visible-light LED, or microphone.

AI operations can be performed on the data provided by the one or more sensors 108 included in and/or coupled to the computing device 100 and/or the one or more sensors included in the vehicle using the AI model 105. The processing resource 102 can include components configured to perform AI operations. In some examples, AI operations can include machine learning or neural network operations, which may include training operations or inference operations, or both. The processing resource 102 can provide an output of the AI model 105.

The controller 106 can generate one or more commands in response to the output of the AI model 105. The one or more commands can include instructions to provide information, perform a function, and/or initiate autonomous driving of the vehicle. The controller 106 can send the one or more commands to the computing device 100 and/or the vehicle.

The computing device 100 can execute the one or more commands. Execution of the one or more commands can include providing information to a person located inside the vehicle. For example, medical information (e.g., heartrate, oxygen level, etc.) of a driver or passenger or directions to a nearest hospital or nearest mechanic could be provided.

The information can be provided via user interface 109. The user interface 109 can be generated by computing device 100 in response to one or more commands from controller 106. The user interface 109 can be a graphical user interface (GUI) that can provide and/or receive information to and/or from the user of the computing device 100. In a number of embodiments, the user interface 109 can be shown on a display of the computing device 100.

In some examples, information could be sent to a person located outside of the vehicle. For example, a location of the vehicle, audio, streaming audio, video, streaming video, data from one or more sensors 108 of the computing device 100, data from one or more sensors of the vehicle, a medical report of a person inside the vehicle, and/or a condition of a vehicle could be sent to an emergency contact or an emergency service provider (e.g., hospital, police, fire department, mechanic, tow company) via the computing device 100.

FIG. 2 illustrates an example of a vehicle 220 in accordance with a number of embodiments of the present disclosure. The vehicle 220 can be, but is not limited to, a human operated vehicle, a self-driving vehicle, or a fully autonomous vehicle. The vehicle, as illustrated in FIG. 2, can include a processing resource 222, a memory 225 including an AI model 225 and an autopilot 227, a controller 226, one or more sensors 228, and a user interface 229.

The memory 224 can be volatile or nonvolatile memory. The memory 224 can also be removable (e.g., portable) memory, or non-removable (e.g., internal) memory. For example, the memory 224 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 224 is illustrated as being located within vehicle 220, embodiments of the present disclosure are not so limited. For example, memory 224 can be located on an external apparatus (e.g., enabling computer readable instructions to be downloaded over the Internet or another wired or wireless connection).

Memory 224 can be any type of storage medium that can be accessed by the processing resource 222 to perform various examples of the present disclosure. For example, the memory 224 can be a non-transitory computer readable medium having computer readable instructions (e.g., computer program instructions) stored thereon that are executable by the processing resource 222 to receive the trained AI model 225, receive data associated with a person located in the vehicle 220 from a sensor (e.g., sensor 108 in FIG. 1) included in and/or coupled to a computing device (e.g., computing device 100 in FIG. 1) and data associated with the vehicle 220 from sensor 228 included in and/or coupled to the vehicle 220, input the received data into the AI model 225, and send a command in response to an output of the AI model 225.

The AI model 225 can be trained outside of the vehicle 220. For example, a cloud computing system (e.g., cloud computing system 336 in FIG. 3) can train the AI model 225 with generic data and send the AI model 225 to the vehicle 220. The vehicle 220 can store the AI model 225 in memory 224 of the vehicle 220 and/or memory (e.g., memory 104 in FIG. 1) of the computing device. In some examples, the AI model 225 can be updated and/or replaced periodically or in response to new data being used to train the AI model 225.

The processing resource 222 can receive the AI model 225 directly from a cloud computing system, memory 224 of the vehicle 220, or the memory of the computing device. The processing resource 222 can also receive data. The data can be collected from the one or more sensors included in and/or coupled to the computing device or the one or more sensors 228 included in and/or coupled to the vehicle 220 and can be stored in memory 224 of the vehicle 220 and/or memory of the computing device.

The one or more sensors 228 of the vehicle 220 can collect data associated with a person located in the vehicle 220, for example, the one or more sensors 228 can detect a user's movement, heart rate, temperature, facial expression, body language, identity, eyelids, eye dilation, eye direction, weight, height, and/or voice. The one or more sensors 228 can also collect data associated with the vehicle 220, for example, the one or more sensors 228 can detect a location, speed, surroundings, traffic, traffic signs, traffic lights, and/or state of the vehicle 220. The one or more sensors 228 can include, but are not limited to, an accelerometer, gyroscope, temperature sensor, proximity sensor, camera, fingerprint scanner, retinal scanner, photodiodes, infrared LED, visible-light LED, weight sensor, and/or microphone.

AI operations can be performed on the data from the one or more sensors included in and/or coupled to the computing device and/or the one or more sensors 228 included in and/or coupled to the vehicle 220 using the AI model 225. The processing resource 222 can include components configured to perform AI operations. In some examples, AI operations can include machine learning or neural network operations, which may include training operations or inference operations, or both. The processing resource 222 can provide an output of the AI model 225.

The controller 226 can generate one or more commands in response to the output of the AI model 225. The one or more commands can include instructions to provide information, perform a function, and/or initiate autonomous driving of the vehicle 220. The controller 226 can send the one or more commands to the computing device and/or the vehicle 220.

The vehicle 220 can execute the one or more commands. Execution of the one or more commands can include providing information to a person located inside the vehicle 220. For example, vehicle information, medical information (e.g., heartrate, oxygen level, etc.) of a driver or passenger or directions to a nearest hospital or nearest mechanic could be provided.

The information can be provided via user interface 229, for example. The user interface 229 can be generated by vehicle 220 in response to one or more commands from controller 226. The user interface 229 can be a GUI that can provide and/or receive information to and/or from the user of the vehicle 220. In a number of embodiments, the user interface 229 can be shown on a display of the vehicle 220.

In some examples, information could be sent to a person located outside of the vehicle 220. For example, a location of the vehicle 220, audio, streaming audio, video, streaming video, data from one or more sensors 228 of the vehicle 220, data from one or more sensors of the computing device, a medical report of a person inside the vehicle, and/or a condition of a vehicle could be sent to an emergency contact and/or an emergency service provider (e.g., hospital, police, fire department, mechanic, tow company) via the vehicle 220.

The vehicle 220 can perform one or more functions in response to the one or more commands from the controller 226. For example, the processing resource 222 could establish that the driver's eyes are closed from the one or more sensors 228 of the vehicle 220 and/or the one or more sensors of the computing device and determine that the driver is asleep. In response to this determination, the controller 226 can send a command to the vehicle 220 to, for example, honk the horn or turn on the radio to wake the driver.

The autopilot 227 of the vehicle 220 can be initiated or terminated in response to the one or more commands from the controller 226. The autopilot 227 can enable the vehicle to self-drive or be fully autonomous. For example, the processing resource 222 could establish the driver's eyes are dilated from the one or more sensors 228 of the vehicle 220 and/or the one or more sensors of the computing device and determine that the driver is intoxicated. In response to this determination, the controller 226 can send a command to the vehicle 220 to initiate autopilot 227.

FIG. 3 illustrates an example of a system 330 including a computing device 300 and a vehicle 320 in accordance with a number of embodiments of the present disclosure. Computing device 300 can correspond to computing device 100 in FIG. 1 and vehicle 320 can correspond to vehicle 220 in FIG. 2. The system 330 can include a wide area network (WAN) 332 and a local area network (LAN) 334. The LAN 334 can include the computing device 300 and the vehicle 320. The WAN 332 can further include a cloud computing system 336 and a communication device 338.

The WAN 332 can be a distributed computing environment, the Internet, for example, and can include a number of servers that receive information from and transmit information to the cloud computing system 336, the communication device 338, the computing device 300, and/or the vehicle 320. Memory and processing resources can be included in the cloud computing system 336 to perform operations on data. The cloud computing system 336 can receive and transmit information to the communication device 338, the computing device 300, and/or the vehicle 320 using the WAN 332. As previously described, the computing device 300 and/or the vehicle 320 can receive an AI model from cloud computing system 336.

The cloud computing system 336 can train the AI model with generic data. The generic data can be data from manufacturers of the one or more sensors, the computing device 300, and/or the vehicle 320. For example, the generic data can be data collected from a manufacturer's in field testing. In some examples, the generic data can be collected from other computing devices and/or vehicles.

The LAN 334 can be a secure (e.g., restricted) network for communication between the computing device 300 and the vehicle 320. The LAN 334 can include a personal area network (PAN), for example Bluetooth or Wi-Fi Direct. In some examples, a number of computing devices within or within a particular distance of the vehicle 320 can transmit and/or receive data via LAN 334. The sensor data from the computing device 300 and/or the vehicle 320 can be solely used for AI operations within the LAN 334 to protect user data from theft. For example, sensor data from computing device 300 and/or vehicle 320 will not be used and/or transmitted outside of the LAN 334 unless permitted by the user of the computing device 300 and/or the vehicle 320.

In a number of embodiments, data can be transmitted to a communication device 338 via WAN 332 in response to a command from the computing device 300 and/or the vehicle 320. The communication device 338 could be a computer, a wearable device, or a mobile device of an emergency contact set by the user or an emergency service provider (e.g., hospital, police, fire department, mechanic, tow company), for example. Data sent to communication device 338 located outside of the vehicle 320 could provide a location of the vehicle 320, audio, streaming audio, video, streaming video, data from one or more sensors, a medical report of a person inside the vehicle 320, and/or a condition of the vehicle 320.

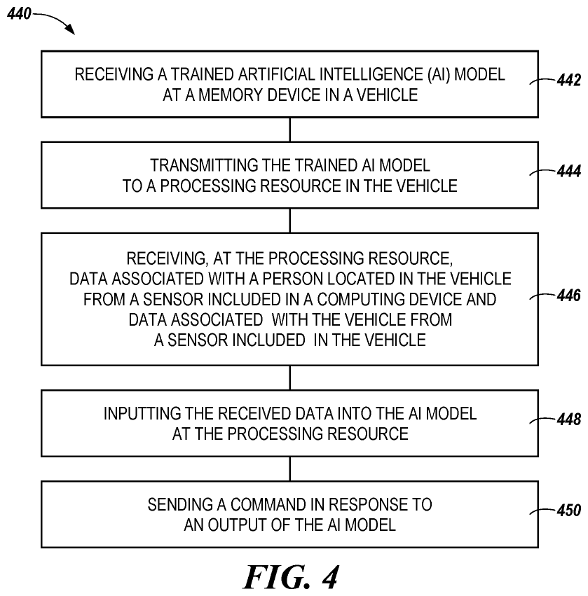

FIG. 4 is a flow diagram of a method 440 for sensor monitoring in a vehicle in accordance with a number of embodiments of the present disclosure. At block 442, the method 440 can include receiving a trained AI model at a memory device in a vehicle.

The trained AI model can be trained outside of the vehicle. For example, a cloud computing system can train the AI model with generic data. The generic data can include data from manufacturers of the one or more sensors, the computing device, and/or the vehicle. In some examples, the generic data can be collected from other computing devices and/or vehicles.

The AI model can be sent to the vehicle via a WAN. The WAN can be a distributed computing environment and can include a number of servers that receive information from and transmit information to the cloud computing system, a communication device, the computing device, and/or the vehicle via a wired or wireless network.

The AI model can be stored in a memory device included in a computing device and/or included in the vehicle. In some examples, the trained AI model can be updated periodically and/or in response to new generic data being used to train the AI model.

At block 444, the method 440 can include transmitting the trained AI model to a processing resource in the vehicle. The processing resource can receive the trained AI model from the memory device or directly from the cloud computing system.

At block 446, the method 440 can include receiving, at the processing resource, data associated with a person located in the vehicle from a sensor included in a computing device and data associated with the vehicle from a sensor included in the vehicle. The sensor included in the computing device and/or the sensor included in the vehicle can be an accelerometer, gyroscope, temperature sensor, proximity sensor, camera, fingerprint scanner, retinal scanner, photodiode, infrared LED, visible-light LED, weight sensor, and/or microphone. In some examples, the data can be stored in a memory device included in the computing device and/or included in the vehicle.

At block 448, the method 440 can include inputting the received data into the AI model at the processing resource. The sensor data from the computing device and/or the vehicle can be solely used for AI operations within the LAN to protect user data from theft. For example, sensor data from the computing device and/or the vehicle will not be used and/or transmitted outside of the LAN unless permitted by the user of the computing device and/or the vehicle.

AI operations can be performed on the data using the AI model. The processing resource can include components configured to perform AI operations. In some examples, AI operations can include machine learning or neural network operations, which may include training operations or inference operations, or both.

At block 450, the method 440 can include sending a command in response to an output of the AI model. The commands can be sent to and executed by the computing device and/or the vehicle. Commands can include instructions to provide information, perform a function, and/or initiate autonomous driving of the vehicle. For example, data can be transmitted to a communication device via WAN and/or the autopilot of the vehicle can be initiated in response to a command from the computing device and/or the vehicle.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a trained artificial intelligence (AI) model at a memory device in a vehicle;
transmitting the trained AI model to a processing resource in the vehicle;
receiving, at the processing resource, data associated with a person located in the vehicle from a sensor included in a computing device and data associated with the vehicle from a sensor included in the vehicle;
inputting the received data into the AI model at the processing resource; and
sending a command in response to an output of the AI model.

2. The method of claim 1, wherein the data associated with the person located in the vehicle includes at least one of a heart rate, movement, or temperature of the person located in the vehicle.

3. The method of claim 1, wherein the data associated with the vehicle includes at least one of a location, speed, surroundings, traffic, traffic signs, traffic lights, or state of the vehicle.

4. The method of claim 1, further comprising providing information to at least one of an emergency contact or an emergency service in response to the command.

5. The method of claim 4, wherein the information includes at least one of a location of the vehicle, streaming audio, streaming video, the data associated with the person located in the vehicle, or the data associated with the vehicle.

6. The method of claim 4, further comprising providing the information via at least one of the vehicle or the computing device.

7. The method of claim 1, further comprising providing information to the person located in the vehicle in response to the command.

8. The method of claim 7, wherein the information includes directions to a nearest hospital or a nearest mechanic.

9. The method of claim 7, further comprising providing the information via at least one of the vehicle or the computing device.

10. An apparatus, comprising:
a processing resource configured to:
receive a trained artificial intelligence (AI) model;
receive data associated with a person located in a vehicle from a sensor included in a computing device and data associated with the vehicle from a sensor included in the vehicle; and
input the received data into the AI model; and
a controller configured to:
send a command in response to an output of the AI model.

11. The apparatus of claim 10, wherein the apparatus is the vehicle or the computing device.

12. The apparatus of claim 10, further comprising a memory device configured to store at least one of the trained AI model or the received data.

13. The apparatus of claim 10, wherein the AI model is received from a cloud computing system.

14. The apparatus of claim 10, wherein the computing device is a wearable device, a medical device, or a mobile device.

15. The apparatus of claim 10, wherein the command initiates an autopilot of the vehicle.

16. A system, comprising:
a computing device including a sensor; and
a vehicle including:
a sensor;
a processing resource configured to:
receive a trained artificial intelligence (AI) model;
receive data associated with a person located in the vehicle from the sensor included in the computing device and data associated with the vehicle from the sensor included in the vehicle; and
input the received data into the AI model; and
a controller configured to send a command in response to an output of the AI model.

17. The system of claim 16, further comprising a network configured to communicatively couple the computing device and the vehicle.

18. The system of claim 17, wherein the computing device accesses the network in response to the computing device being located within the vehicle.

19. The system of claim 17, wherein the network is a wireless personal area network (WPAN).

20. The system of claim 16, wherein the trained AI model is trained outside of the vehicle with generic data.
